(19) United States
(12) Patent Application Publication
(10) Pub. No.: US 2016/0160834 A1
(43) Pub. Date: Jun. 9, 2016

(54) HYDRAULIC MACHINE

(71) Applicant: KABUSHIKI KAISHA TOSHIBA, Minato-ku (JP)

(72) Inventors: Pohan KO, Yokohama (JP); Eiki TAKEDA, Yokohama (JP); Atsuhito NISHIMOTO, Kawasaki (JP)

(73) Assignee: KABUSHIKI KAISHA TOSHIBA, Minato-ku (JP)

(21) Appl. No.: 14/936,101

(22) Filed: Nov. 9, 2015

(30) Foreign Application Priority Data
Dec. 9, 2014 (JP) 2014-249235

(51) Int. Cl. F03B 3/02; F03B 3/12; F03B 3/18

(52) U.S. Cl. CPC F03B 3/02; F03B 3/183; F03B 3/125

(57) ABSTRACT

A hydraulic machine according to embodiments described herein includes a channel defining member, a plurality of guide vanes, and a runner. The channel defining member defines a channel. Each of the guide vanes can turn about a turning axis. The runner is provided on an inner peripheral side of the guide vanes. The guide vane has a pair of edges facing the channel defining member. A disc member is provided to at least one of the edges of the guide vane. The disc member is buried in the channel defining member and includes a central axis which is the turning axis. The disc member overlaps with at least one of an upstream end of a downstream end of the guide vane when viewed from a direction along the turning axis.

### CROSS-REFERENCE TO RELATED APPLICATIONS

This application is based upon and claims the benefit of priority from Japanese Patent Application No.2014-249235, filed Dec. 9, 2014; the entire contents of which are incorporated herein by reference.

### FIELD

Embodiments described herein relate generally to a hydraulic machine.

### BACKGROUND

In a hydraulic machine such as a Francis turbine and a pump turbine, water flows into a spiral casing from an upper reservoir through a water pressure pipe, and the water flew into the casing flows into a runner through a stay vane and a guide vane. The runner is rotationally driven by the water flew into the runner. When the runner is rotationally driven, a generator connected to the runner via a main shaft is driven and generates power. The water which has rotationally driven the runner flows out from the runner to a lower reservoir (or a trailrace) through a draft tube.

A guide vane is disposed on a downstream side of a stay vane and on an upstream side of a runner and formed turnably as a movable guide vane (wicket gate). In this manner, a flow amount of the water flowing into the runner is adjusted. Further, a flow direction of the water flowing into the runner can be changed by turning the guide vane. Therefore, a direction of a relative velocity vector of a flow at an inlet of the runner can be set along a runner vane form.

As described above, without relating to a flow amount change, a rotation speed of a water turbine can be maintained at a rated rotation speed, and performance of a water turbine can be maintained to intended performance in a wide operation range.

However, to turn a guide vane, a gap is provided between the guide vane and a channel defining member (static portion) such as an upper cover and a lower cover adjacent to the guide vane. The gap is called a side gap of a guide vane. When water flows in the side gap, a leak flow through the side gap is formed, and a leakage loss is caused. Consequently, performance of a water turbine might be degraded. This performance degradation tends to be remarkable when a specific speed of a water turbine is increased.

### BRIEF DESCRIPTION OF THE DRAWINGS

FIG. 1 is a meridian plane cross-section view partially illustrating a Francis turbine according to a first embodiment;

FIG. 2 is an enlarged view of FIG. 1 and a sectional view and an top view illustrating a guide vane;

FIG. 3 is a sectional view and an top view illustrating a guide vane according to a second embodiment;

FIG. 4 is a sectional view and an top view illustrating a variation of FIG. 3; and

FIG. 5 is an top view illustrating an additional vane according to a third embodiment.

### DETAILED DESCRIPTION

A hydraulic machine according to embodiments described herein includes a channel defining member, a plurality of guide vanes, and a runner. The channel defining member defines a channel. The plurality of guide vanes are provided in the channel and arranged separately in a circumferential direction, and each of the guide vanes can turn about a turning axis. The runner is provided on an inner peripheral side of the guide vane and rotationally driven by a flow flowing into through the guide vane. The guide vane has a pair of edges facing the channel defining member. A disc member is provided to at least one of the edges of the guide vane. The disc member is buried in the channel defining member and includes a central axis which is a turning axis. The disc member overlaps with at least one of an upstream end of a downstream end of the guide vane when viewed from a direction along the turning axis.

A hydraulic machine according to the embodiments described herein will be described below with reference to the drawings.

### First Embodiment

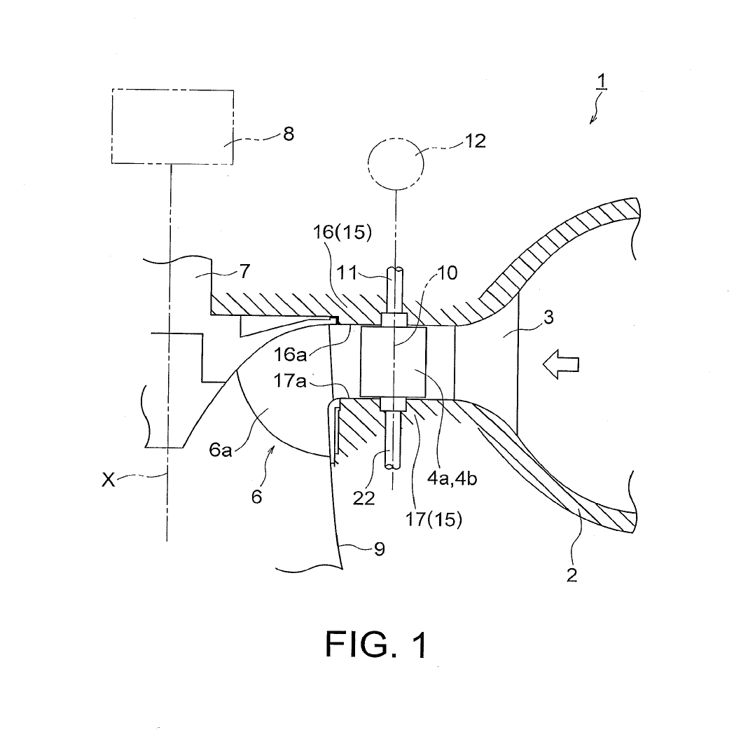

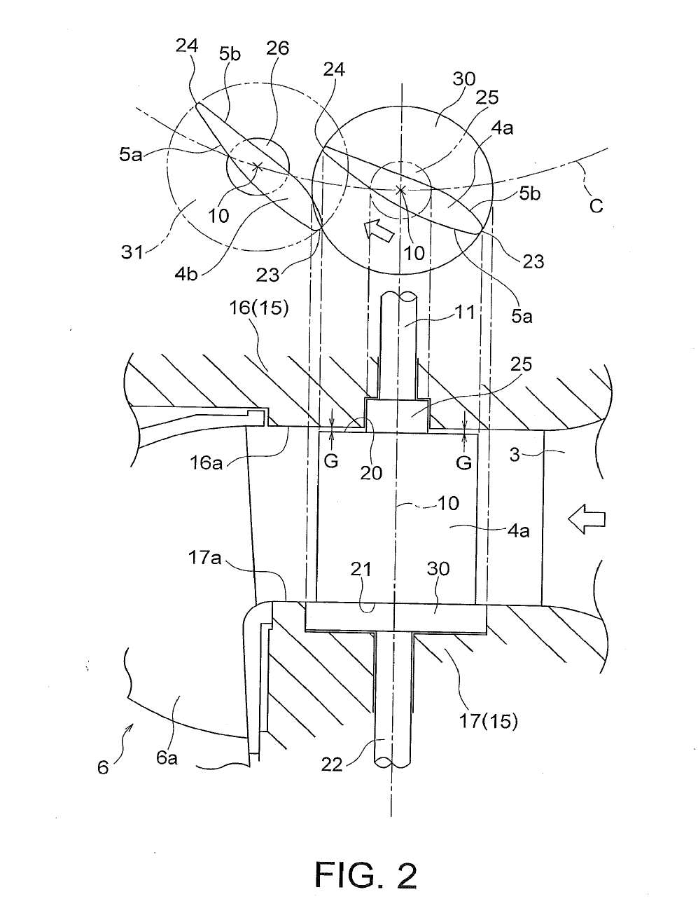

A hydraulic machine according to a first embodiment will be described by using FIGS. 1 and 2. First, by using FIG. 1, a Francis turbine will be described as an example of the hydraulic machine.

As illustrated in FIG. 1, a Francis turbine 1 includes a spiral casing 2, a plurality of stay vanes 3, a plurality of guide vanes 4a and 4b, and a runner 6. Water flows into the casing 2 from an upper reservoir (not illustrated) through a water pressure pipe (not illustrated) while the turbine is operated.

The stay vanes 3 are provided on an inner peripheral side of the casing 2. The guide vanes 4a and 4b are provided on inner peripheral sides of the stay vanes 3. The runner 6 is provided on an inner peripheral side of the guide vanes 4a and 4b.

The stay vanes 3 are arranged separately in a circumferential direction. A channel is formed between the stay vanes 3 adjacent to each other. Water flowing from the casing 2 flows in each channel (see a thick line arrow in FIG. 1). The stay vanes 3 guide the flow of water flowing from the casing 2 to the guide vanes 4a and 4b.

Similarly, the guide vanes 4a and 4b are arranged separately in a circumferential direction (see FIG. 2). A channel is formed between the guide vanes 4a and 4b adjacent to each other. Water flowing from the stay vanes 3 flows in each channel (see a thick line arrow in FIG. 2). The guide vanes 4a and 4b guide the flow of water flowing from the stay vanes 3 to the runner 6.

As illustrated in FIG. 1, the runner 6 is rotationally driven by the flow of water flowing from the casing 2 through the stay vanes 3 and the guide vanes 4a and 4b. Specifically, the runner 6 includes a plurality of runner vanes 6a arranged separately in a circumferential direction, and a channel is formed between the runner vanes 6a adjacent to each other.

Water flowing from the guide vanes 4a and 4b flows in each channel. The runner 6 can rotate around a rotation axis X. Thus, the runner 6 is rotationally driven when the runner vanes 6a receive pressure from water flowing into through the guide vanes 4a and 4b.

A generator 8 is connected to the runner 6 via a main shaft 7. The generator 8 generates power while a water turbine is operated. Further, a draft tube 9 is provided on a downstream side of the runner 6 while the water turbine is operated. The draft tube 9 is connected to a lower reservoir (or a trailrace) (not illustrated) and discharges the water which has rotationally driven the runner 6.

The Francis turbine 1 according to the embodiment may perform a pumping operation. During the pumping operation, the generator 8 rotationally drives the runner 6 by operating as an electric motor, and water in the draft tube 9 is sucked and pumped by the runner 6. The water sucked by the runner 6 flows into the casing 2 through the guide vanes 4a and 4b and the stay vanes 3 and is discharged from the casing 2 to an upper reservoir through a water pressure pipe. In this case, the guide vanes 4a and 4b and the stay vanes 3 guide water flowing from the runner 6 to the casing 2.

As illustrated in FIG. 2, each of the guide vanes 4a and 4b can turn about a turning axis 10 extending substantially in parallel to the rotation axis X of the runner 6, and angles of the guide vanes 4a and 4b can be changed. Accordingly, a channel area (a guide vane opening degree) formed between the guide vanes 4a and 4b adjacent to each other can be adjusted. Therefore, the amount of a flow to the runner 6 disposed on a downstream side is changed, and also a relative velocity vector of the flow to the runner 6 is directed along the shape of the runner vanes 6a. During a pumping operation, opening degree of the guide vanes 4a and 4b are adjusted to a proper pumping discharge rate depending on a pumping head. The turning axis of the guide vanes 4a and 4b are disposed on a predetermined pitch circle C when viewed from a direction along the rotation axis X of the runner 6.

Further, as illustrated in FIG. 1, a guide ring (not illustrated) is connected to each of the guide vanes 4a and 4b via a corresponding spindle 11 and a guide vane arm (not illustrated). A guide vane driving unit 12 (for example, a servo motor) is connected to the guide ring. In this manner, the guide vane driving unit 12 integrally turns each of the guide vanes 4a and 4b and adjusts opening degree of the guide vanes 4a and 4b. Further, a control unit (not illustrated) is connected to the guide vane driving unit 12 so that the control unit can control the guide vane driving unit 12. Thus, since the control unit controls the guide vane driving unit 12, the guide vane driving unit 12 changes a guide vane opening degree by turning the guide vanes 4a and 4b in a clockwise direction or a counterclockwise direction when viewed from a direction along the turning axis 10.

As illustrated in FIG. 2, a channel in which the guide vanes 4a and 4b are provided, is defined by a channel defining member 15. The channel defining member 15 includes an upper cover 16 and a lower cover 17 facing each other. The guide vanes 4a and 4b are intervened between the upper cover 16 and the lower cover 17 and provided to a channel formed between the upper cover 16 and the lower cover 17. More specifically, the upper cover 16 includes a channel defining surface 16a provided on sides (lower sides) of the guide vanes 4a and 4b. The lower cover 17 includes a channel defining surface 17a provided on sides (upper sides) of the guide vanes 4a and 4b. A channel is formed between the channel defining surfaces 16a and 17a, and the guide vanes 4a and 4b are provided in the formed channel.

The guide vanes 4a and 4b include an upper side edge 20 facing the upper cover 16 and a lower side edge 21 facing the lower cover 17. The above-described spindle 11 is connected to the upper side edge 20 and extends to a guide vane arm through the upper cover 16. A stem 22 is connected to the lower side edge 21 of the guide vanes 4a and 4b. The stem 22 extends in the lower cover 17 and supports the guide vanes 4a and 4b turnably with respect to the lower cover 17.

An top view of FIG. 2 illustrates the first guide vane 4a and the second guide vane 4b adjacent to each other in a circumferential direction. Among them, a lower side circular plate 30 (a lower side disc member) is intervened between the first guide vane 4a and the stem 22. Specifically, the lower side circular plate 30 is provided to the lower side edge 21 of the first guide vane 4a and buried in the lower cover 17. Further, the turning axis 10 is a central axis in the lower side circular plate 30, and the lower side circular plate 30 is fixed to the first guide vane 4a and turned concentrically with the guide vane 4a. According to the embodiment, a connection member 25 is provided to the upper side edge 20 of the first guide vane 4a. This connection member 25 is provided for connecting the first guide vane 4a and the spindle 11 and formed in a circular plate shape with a smaller diameter than a diameter of the lower side circular plate 30. The diameter of the connection member 25 is determined in accordance with a material strength to be used. In general, the diameter is larger than a maximum thickness of the first guide vane 4a.

The lower side circular plate 30 overlaps with both of an upstream end 23 and a downstream end 24 of the first guide vane 4a when viewed in a direction along the turning axis 10 (for example, viewed as an top view). Specifically, the lower side circular plate 30 is formed from the upstream end 23 to the downstream end 24 at the lower side edge 21 of the first guide vane 4a and formed so as to cover the whole of the lower side edge 21 of the first guide vane 4a. When viewed from a direction along the turning axis 10, the upstream end 23 and the downstream end 24 of the first guide vane 4a may correspond (or match) with an outer edge of the lower side circular plate 30 or may be disposed on an inner side of the lower side circular plate 30. In the latter case, the outer edge of the lower side circular plate 30 is arranged on a radial outer side in the case of setting the turning axis 10 as a central axis, in comparison with the upstream end 23 and the downstream end 24 of the first guide vane 4a.

An upper side circular plate 31 (upper side disc member) similar to the lower side circular plate 30 is provided to the upper side edge 20 of the second guide vane 4b adjacent to the first guide vane 4a in a circumferential direction (on a downstream side). On the other hand, a connection member 26 similar to the above-described connection member 25 is provided on a lower side edge 21 of the second guide vane 4b. Thus, the upper side circular plate 31 corresponding to the second guide vane 4b, which is one of the guide vanes 4a and 4b adjacent to each other in a circumferential direction, is provided to the upper side edge 20 of the second guide vane 4b. The lower side circular plate 30 corresponding to the first guide vane 4a is provided to the lower side edge 21 of the first guide vane 4a. In other words, the second guide vane 4b in which the upper side circular plate 31 is provided to the upper side edge 20 and the first guide vane 4a in which the lower side circular plate 30 is provided to the lower side edge 21 are alternately arranged in a circumferential direction. The upper side circular plate 31 corresponding to the second guide vane 4b is intervened between the second guide vane 4b and the spindle 11, and the upper side circular plate 31 is buried in the upper cover 16.

Surfaces on the sides of the guide vanes 4a and 4b of the circular pates 30 and 31 are preferably formed in a stream-line form so as to continuously connect with the channel defining surfaces 16a and 17a of the upper cover 16 and the lower cover 17. Accordingly, it is prevented that a gap is formed between the surfaces on the sides of the guide vanes 4a and 4b of the circular pates 30 and 31 and the channel defining surfaces 16a and 17a of the upper cover 16 and the lower cover 17 and prevented that water flow loss occurs. In this case, the circular pates 30 and 31 are not present in a channel defined between the channel defining surface 16a of the upper cover 16 and the channel defining surface 17a of the lower cover 17. Further, in this case, the lower side edge 21 of the first guide vane 4a is positioned on a surface on the side of the first guide vane 4a of the lower side circular plate 30 so as not to form the side gap (see G in FIG. 2) near the lower side edge 21 of the first guide vane 4a. Similarly, the upper side edge 20 of the second guide vane 4b is positioned on a surface on the side of the second guide vane 4b of the upper side circular plate 31 so as not to form the side gap (see G in FIG. 2) near the upper side edge 20 of the second guide vane 4b.

Next, an action of the embodiment including such a configuration will be described.

While a water turbine is operated, water flows from the stay vanes 3 to the runner 6 via the guide vanes 4a and 4b. Water flew from the stay vanes 3 into the guide vanes 4a and 4b is guided to a desired direction by the guide vanes 4a and 4b and flows to the runner 6.

As described above, the lower side circular plate 30 is provided to the lower side edge 21 of the first guide vane 4a, and when viewed from a direction along the turning axis 10, the lower side circular plate 30 overlaps with both of the upstream end 23 and the downstream end 24 of the first guide vane 4a. Accordingly, it is prevented that the side gap is formed from the upstream end 23 to the downstream end 24 at the lower side edge 21 of the first guide vane 4a. Therefore, water flowing near the lower side edge 21 of the first guide vane 4a flows along a pressure surface 5a (outer peripheral side surface) or a suction surface 5b (inner peripheral side surface) of the first guide vane 4a, and a leak flow flowing through the side gap is not formed. The upper side circular plate 31 is provided to the upper side edge 20 of the second guide vane 4b adjacent to the first guide vane 4a in a circumferential direction, and water flowing near the upper side edge 20 of the second guide vane 4b flows along the pressure surface 5a or the suction surface 5b of the second guide vane 4b, and a leak flow flowing through the side gap is not formed.

According to the above-described embodiment, the lower side circular plate 30 (or the upper side circular plate 31) is provided to the lower side edge 21 (or the upper side edge 20) of the guide vanes 4a and 4b, and when viewed from a direction along the turning axis 10, the lower side circular plate 30 overlaps with both of the upstream end 23 and the downstream end 24 of the guide vanes 4a and 4b. Accordingly, it is prevented that the side gap is formed from the upstream end 23 to the downstream end 24 of the guide vanes 4a and 4b at the lower side edge 21 (or the upper side edge 20) of the guide vanes 4a and 4b. Therefore, a leak flow flowing through the side gap can be reduced, and performance of a water turbine can be improved.

To secure closing characteristics of the guide vanes 4a and 4b in an emergency, the upstream ends 23 of the guide vanes 4a and 4b overlap with the downstream ends 24 of the guide vanes 4a and 4b adjacent to each other in a circumferential direction in a closing state. Therefore, if the lower side circular plates 30 (or the upper side circular plate 31) are provided to the lower side edges 21 (or the upper side edges 20) of both of the guide vanes 4a and 4b adjacent to each other, the lower side circular pates 30 might be interfered each other. However, according to the embodiment, the upper side circular plate 31 corresponding to the first guide vane 4a, which is one of the guide vanes 4a and 4b adjacent to each other, is provided to the upper side edge 20 of the first guide vane 4a. The lower side circular plate 30 corresponding to the second guide vane 4b, which is another of the guide vanes 4a and 4b, is provided to the lower side edge 21 of the second guide vane 4b. Accordingly, it is prevented that the lower side circular plate 30 (or the upper side circular plate 31) is provided to the lower side edges 21 (or the upper side edges 20) of both of the guide vanes 4a and 4b adjacent to each other and prevented that the lower side circular pates 30 are interfered each other. In other words, according to the embodiment, closing characteristics of the guide vanes 4a and 4b can be secured while reducing a leak flow flowing through the side gaps of the guide vanes 4a and 4b, the guide vanes 4a and 4b can be fully closed by a flow pressure on an upstream side of the guide vanes 4a and 4b without depending on an opening degree even in an emergency such as control power loss, and the guide vanes 4a and 4b can be automatically closed.

### Second Embodiment

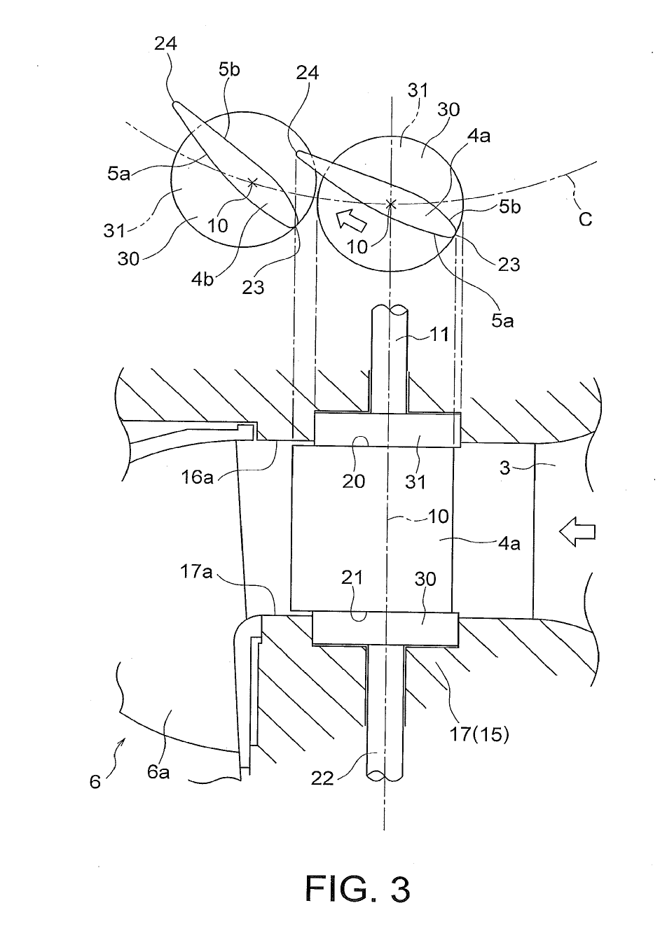

Next, a hydraulic machine according to a second embodiment of the present invention will be described by using FIG. 3.

In the second embodiment illustrated in FIG. 3, configurations are substantially the same as the first embodiment illustrated in FIGS. 1 and 2 mainly other than that one of an upstream end and a downstream end of a guide vane is disposed on an outer side of a disc member when viewed from a direction along a turning axis. The same portions as the first embodiment illustrated in FIGS. 1 and 2 are denoted by the same reference signs in FIG. 3, and detailed descriptions thereof are omitted.

As illustrated in FIG. 3, circular pates 30 and 31 are provided to both of an upper side edge 20 and a lower side edge 21 of guide vanes 4a and 4b. Specifically, the upper side circular plate 31 is provided to each upper side edge 20 of the first guide vane 4a and the second guide vane 4b, and the lower side circular plate 30 is provided to each lower side edge 21. Such guide vanes 4a and 4b are disposed in a circumferential direction.

In the embodiment, when viewed from a direction along a turning axis 10, downstream ends 24 of the guide vanes 4a and 4b are disposed on outer sides of the circular pates 30 and 31. Accordingly, the diameters of the circular pates 30 and 31 illustrated in FIG. 3 are smaller than the diameters of the circular pates 30 and 31 illustrated in FIG. 2. The circular pates 30 and 31 and the turning axis 10 illustrated in FIG. 3 are eccentrically positioned on the sides of the upstream ends 23 of the guide vanes 4a and 4b in comparison with the circular pates 30 and 31 and the turning axis 10 illustrated in FIG. 2.

The circular pates 30 and 31 preferably have a large diameter capable of preventing that the circular pates 30 and 31 adjacent to each other are interfered each other. On the other hand, if the circular pates 30 and 31 cover regions on the sides of the upstream ends 23 of the guide vanes 4a and 4b in which a leak flow formed to the side gap tends to be easy to be relatively formed, a leak flow flowing through the side gap can be effectively suppressed, and performance of a water turbine can be effectively improved. Therefore, the circular pates 30 and 31 overlap with at least upstream ends 23 of the guide vanes 4a and 4b when viewed from a direction along the turning axis 10. In this case, the upstream ends 23 of the guide vanes 4a and 4b may correspond (or match) with outer edges of the circular pates 30 and 31 or may be disposed on inner sides of the circular pates 30 and 31. Although the diameters of the circular pates 30 and 31 are not especially limited if the guide vanes 4a and 4b can be smoothly tuned, for example, the diameters may be equal to or greater than ⅓ or more, preferably equal to or greater than ½, of a chord length L of the guide vanes 4a and 4b. In the latter case, the circular pates 30 and 31 overlap with both of the upstream ends 23 of the guide vanes 4a and 4b and a center point of a chord when viewed from a direction along the turning axis 10.

According to the above-described embodiment, each of the circular pates 30 and 31 is provided to both of the upper side edge 20 and the lower side edge 21 of the guide vanes 4a and 4b. Accordingly, it can be suppressed that the side gaps of the guide vanes 4a and 4b are formed at the upper side edges 20 and the lower side edges 21 of the guide vanes 4a and 4b. Therefore, a leak flow flowing through the side gap can be reduced, and performance of a water turbine can be improved.

Further, according to the embodiment, when viewed from a direction along the turning axis 10, the downstream ends 24 of the guide vanes 4a and 4b are disposed on outer sides of the circular pates 30 and 31. Accordingly, in the case where the upstream ends 23 of the guide vanes 4a and 4b are formed so as to overlap with the downstream ends 24 of the adjacent guide vanes 4a and 4b in a closing state, it is prevented that the circular pates 30 and 31 adjacent to each other in a circumferential direction are interfered each other. Therefore, while reducing a leak flow flowing through the side gaps of the guide vanes 4a and 4b, closing characteristics of the guide vanes 4a and 4b can be secured.

Further, according to the embodiment, as described above, when viewed from a direction along the turning axis 10, the upstream ends 23 of the guide vanes 4a and 4b overlap with the circular pates 30 and 31, and the downstream ends 24 are disposed on an outer side of the circular pates 30 and 31. In this case, the circular pates 30 and 31 can cover regions on the sides of the upstream ends 23 of the guide vanes 4a and 4b in which a leak flow formed to the side gap tends to be easy to be relatively formed, a leak flow flowing through the side gap can be effectively suppressed, and performance of a water turbine can be effectively improved.

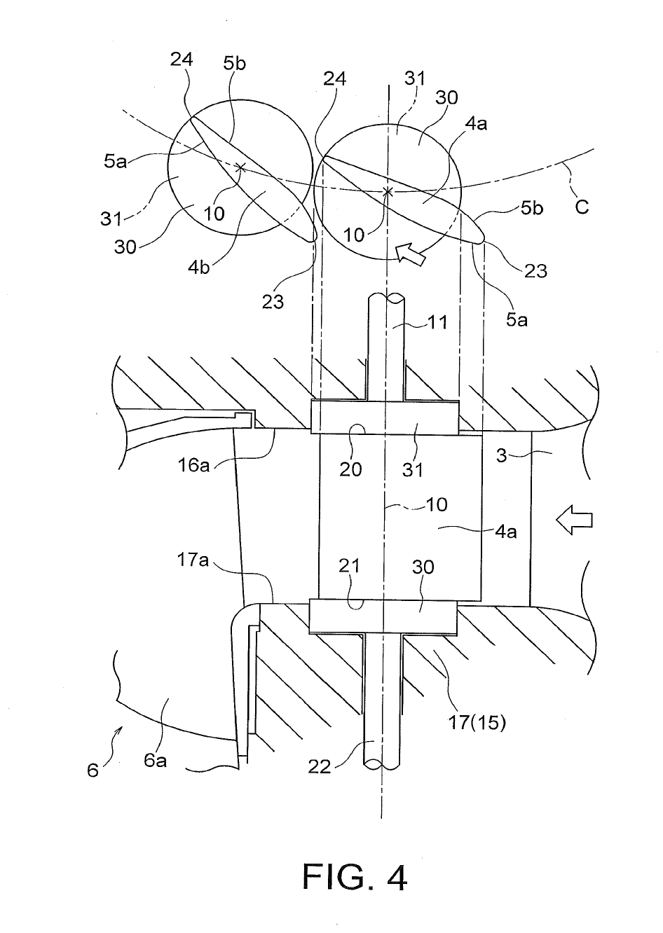

In the above-described embodiment, an example has been described in which the downstream ends 24 of the guide vanes 4a and 4b are disposed on outer sides of the circular pates 30 and 31 when viewed from a direction along the turning axis 10. However, without being limited to the above, the upstream ends 23 of the guide vanes 4a and 4b may be disposed on outer sides of the circular pates 30 and 31 as illustrated in FIG. 4 when viewed from a direction along the turning axis 10. In this case, diameters of the circular pates 30 and 31 are smaller than diameters of the circular pates 30 and 31 illustrated in FIG. 2. The circular pates 30 and 31 and the turning axis 10 illustrated in FIG. 4 are eccentrically positioned on the side of the downstream end 24 of the guide vanes 4a and 4b in comparison with the circular pates 30 and 31 and the turning axis 10 illustrated in FIG. 2. In the embodiment illustrated in FIG. 4, the circular pates 30 and 31 can cover regions on the sides of the downstream ends 24 of the guide vanes 4a and 4b, a leak flow flowing through the side gap can be suppressed, and performance of a water turbine can be improved. Further, the turning axis 10 is eccentrically positioned on the side of the downstream ends 24 of the guide vanes 4a and 4b. Therefore, a distance between the turning axis 10 and the upstream ends 23 of the guide vanes 4a and 4b can be increased, and a pressure, which acts in a closing direction and which is one of the pressures applied to pressure surfaces 5a of the guide vanes 4a and 4b by a water flow, can be increased. Therefore, closing characteristics of the guide vanes 4a bad 4b can be further secured.

### Third Embodiment

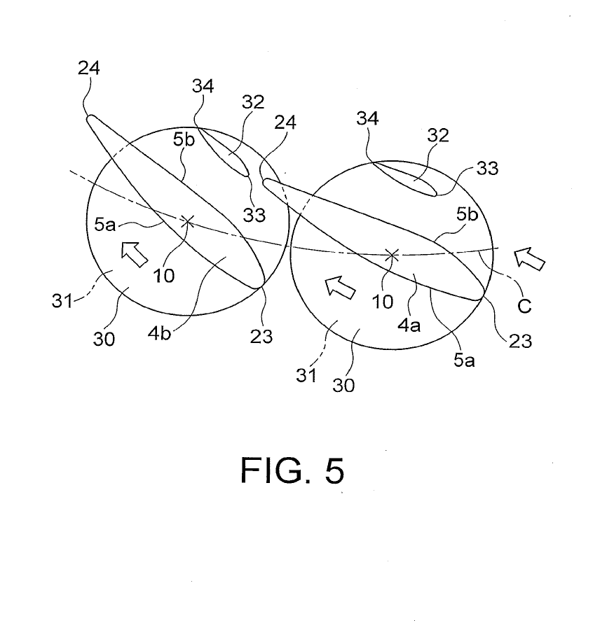

Next, a hydraulic machine according to a third embodiment of the present invention will be described by using FIG. 5.

In the third embodiment illustrated in FIG. 5, configurations are substantially the same as the second embodiment illustrated in FIG. 3 mainly other than that an additional vane disposed on the side of a suction surface of a guide vane is provided to the circulate plate. In FIG. 5, the same portions as the second embodiment illustrated in FIG. 3 are denoted by the same reference signs, and detailed descriptions thereof are omitted.

Circular pates 30 and 31 according to the embodiment are the circular pates 30 and 31 illustrated in FIG. 3 according to the second embodiment. Specifically, each of the upper side circular plate 31 and the lower side circular plate 30 is provided to both of the upper side edges 20 and the lower side edges 21 of the guide vanes 4a and 4b as illustrated in FIG. 3. Although the upstream ends 23 of the guide vanes 4a and 4b overlap with the circular pates 30 and 31 when viewed from a direction along the turning axis 10, the downstream ends 24 of the guide vanes 4a and 4b are disposed on the outer sides of the circular pates 30 and 31.

In the embodiment, as illustrated in FIG. 5, an additional vane 32 is provided to the circular pates 30 and 31. The additional vane 32 is disposed on the side of the suction surface 5b of the guide vanes 4a and 4b. The additional vane 32 is disposed on a downstream side of a guide vane (for example the first guide vane 4a) adjacent to a corresponding other guide vane (for example the second guide vane 4b) on an upstream side at a design point (an operation point at the most efficient guide vane opening degree). The additional vane 32 is formed so as to extend from the upper side circular plate 31, which is provided to the upper side edge 20 of the guide vanes 4a and 4b, to the lower side circular plate 30, which is provided to the lower side edge 21. Specifically, the additional vane 32 is fixed by being supported by the upper side circular plate 31 and the lower side circular plate 30, and the additional vane 32 turns with the corresponding guide vanes 4a and 4b around the turning axis 10.

A flow (slip stream) flowing from the guide vanes 4a and 4b tends to cause a loss since a pressure is generally reduced. A loss causing to a flow flowing from the guide vanes 4a and 4b can be reduced when the above-described additional vane 32 is disposed on downstream sides of the guide vanes 4a and 4b. Therefore, the additional vane 32 is preferably formed at a position and an angle which can effectively reduce the loss. For example, the additional vane 32 may be disposed along a flow flowing from the guide vanes 4a and 4b on extensions of downstream sides of the guide vanes 4a and 4b. Further, the additional vane 32 preferably has an airfoil shape. However, the additional vane 32 can have an arbitrary shape without being limited to the airfoil shape if increase in a flow loss can be suppressed.

A length (or chord length) from the upstream end 33 to the downstream end 34 of the additional vane 32 may be smaller than a length (or chord length) from the upstream end 23 to the downstream end 24 of the guide vanes 4a and 4b.

Specifically, the additional vane 32 may not be formed so as to extend from the upstream end 23 to the downstream end 24 of the guide vanes 4a and 4b. Therefore, increase in a friction loss caused by the additional vane 32 can be suppressed.

In the embodiment illustrated in FIG. 5, both of the upstream end 33 and the downstream end 34 of the additional vane 32 overlap with the circular pates 30 and 31 when viewed from a direction along the turning axis 10. Specifically, a lower side edge of the additional vane 32 is positioned on a surface on the side of the additional vane 32 of the lower side circular plate 30 so as not to form the side gap near the lower side edge of the additional vane 32. Similarly, an upper side edge of the additional vane 32 is positioned on a surface on the side of the additional vane 32 of the upper side circular plate 31 so as not to form the side gap near the upper side edge of the additional vane 32.

While a water turbine is operated, the additional vane 32 guides a flow to a runner 6 as with the guide vanes 4a and 4b. In this case, the additional vane 32 receives a drag (a friction force by a water viscosity) and a normal force (a pressure received from a water flow). A size of these forces depends on such as a position, an angle, and a shape of the additional vane 32. However, a force acting in a closing direction with respect to the guide vanes 4a and 4b can be provided. Therefore, closing characteristics of the guide vanes 4a and 4b can be further secured.

According to the above-described embodiment, the additional vane 32 disposed on the side of the suction surface 5b of the guide vanes 4a and 4b is provided to the circular pates 30 and 31. Accordingly, a force acting in a closing direction with respect to the guide vanes 4a and 4b can be increased by a force applied to the additional vanes 32 from a water flow. Therefore, closing characteristics of the guide vanes 4a and 4b can be further secured.

Further, according to the embodiment, the additional vane 32 is disposed on a downstream side of the guide vanes 4a and 4b adjacent to the corresponding other guide vanes 4a and 4b on an upstream side at a design point. In this manner, a loss caused to a flow flowing from the guide vanes 4a and 4b can be reduced.

Further according to the embodiment, the circular pates 30 and 31 are provided to both of the upper side edge 20 and the lower side edge 21 of the guide vanes 4a and 4b. The upstream ends 23 of the guide vanes 4a and 4b overlap with the circular pates 30 and 31 when viewed from a direction along the turning axis 10. The downstream ends 24 of the guide vanes 4a and 4b are disposed on outer sides of the circular pates 30 and 31. Accordingly, regions on the sides of the upstream ends 23 of the guide vanes 4a and 4b in which a leak flow formed to the side gap can tend to be easy to be relatively formed can be covered, a leak flow flowing through the side gap can be effectively suppressed, and performance of a water turbine can be effectively improved. With respect to the guide vanes 4a and 4b, a force acting in a closing direction can be increased by the additional vane 32, and closing characteristics of the guide vanes 4a and 4b can be further secured by reinforcing a force in a closing direction.

In the above-described embodiment, an example has been described in which the additional vane 32 is provided to the circular pates 30 and 31 illustrated in FIG. 3. However, without being limited to the above example, the additional vane 32 may be provided to the circular pates 30 and 31 illustrated in FIG. 4. In this case, a force in a closing direction can be reinforced by increasing a force acting in a closing direction with respect to the guide vanes 4a and 4b by the additional vane 32, and closing characteristics of the guide vanes can be further secured. Further, if intensity can be secured, the additional vane 32 may be provided to the circular pates 30 and 31 illustrated in FIG. 2.

According to the above-described embodiments, performance of a water turbine can be improved by reducing a leak flow flowing through the side gap of the guide vanes 4a and 4b.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Further, it will be understood that these embodiments can be at least partially combined properly without departing from the spirit of the present invention.

1. A hydraulic machine, comprising:
a channel defining member configured to define a channel;
a plurality of guide vanes provided in the channel and arranged separately in a circumferential direction, each of the guide vanes being turnable about a turning axis; and
a runner provided on an inner peripheral side of the guide vanes and rotationally driving by a flow flowing through the guide vanes,
wherein the guide vanes include a pair of edges facing the channel defining member, a disc member buried in the channel defining member and including a central axis which is the turning axis is provided to at least one of the edges of the guide vane, and the disc member overlaps with at least one of an upstream end and a downstream end of the guide vane when viewed from a direction along the turning axis.

2. The hydraulic machine according to claim 1, wherein the disc member overlaps with both of the upstream and downstream ends of the guide vane when viewed from a direction along the turning axis.

3. The hydraulic machine according to claim 1, wherein the disc member is provided to both of the edges of the guide vane.

4. The hydraulic machine according to claim 1, wherein an additional vane disposed on a side of a suction surface of the guide vane is provided to the disc member.

5. The hydraulic machine according to claim 4, wherein the additional vane is disposed on a downstream side of the guide vane adjacent to the other guide vane corresponding to said additional vane on an upstream side at a design point.
